(19) United States
(12) Patent Application Publication
(10) Pub. No.: US 2010/0030897 A1
(43) Pub. Date: Feb. 4, 2010

(54) Method and System for Installing a Root Certificate on a Computer With a Root Update Mechanism

(76) Inventor: Rob Stradling, West Yorkshire (GB)

Correspondence Address: ALFRED C. ROTH, 2501 LITTLE RIVER RD., HENDERSONVILLE, NC, 28739, US

(21) Appl. No.: 12/086,274

(22) PCT Filed: Jun. 20, 2007
(86) PCT No.: PCT/US07/71674

§ 371 Date: Sep. 21, 2009

Related U.S. Application Data
(60) Provisional application No. 60/871,032, filed on Dec. 20, 2006.

(51) Int. Cl. G06F 15/173

(52) U.S. Cl. 709/225

(57) ABSTRACT

The invention discloses a method of installing or updating a root certificate on a computer with a root update mechanism by sending a client computer at least one root certificate and a legacy certificate chain. This method can be used to enable extended validation certificates on a computer with a root update mechanism.

### CROSS-REFERENCE TO RELATED APPLICATION

This application claims the benefit of provisional application Ser. No. 60/871,032, filed Dec. 20, 2006, which is incorporated entirely herein by reference.

### TECHNICAL FIELD

This invention relates to digital certificates, specifically a method of updating root certificates on computers that have a root update mechanism.

### BACKGROUND

Computers are an essential part of e-commerce and can be used by electronic merchants to obtain or exchange information, purchase or sell goods or services, etc. Thanks to computers, some merchants no longer need retail stores and conduct business solely over the Internet. Customers may browse the Internet, locate a product from a desired web page, and purchase the product without ever leaving their home.

Unfortunately, the increase in Internet purchasing activity has caused many new types of scams and frauds to emerge and, as a result, consumers have become increasingly worried about their online safety. In response to these scams, developers have designed different ways to maintain security. The Secure Sockets Layer (SSL) security protocol is one such development. The SSL protocol maintains security by using a public key infrastructure during network transactions. During a transaction, the server computer utilizes the SSL connection to transfer certificate information to a client computer for verification. The client computer will then check to make sure that server computer is approved and its identity is assured.

The client computer examines the server computer's certificate information to determine the validity of the server computer. The certificate is considered trusted if the sent certificate is found in the local trusted root storage facility (the one or more places on the client computer where digital certificates are stored). If the certificate is not found, the client computer will try to establish trust by using data associated with the sent certificate to establish a certificate chain by tracing referenced certificates (cross-certificates) in an attempt to locate a trusted certificate. The end point of a certificate chain or the trusted certificate upon which other certificates rely for their verification is called a root certificate. If no certificate chains can be constructed up to a root certificate that is already trusted locally, then computers with an automatic root updating mechanism (which is any mechanism that will update root certificates on a computer) will attempt to download any relevant new root certificates from a root updating facility. The downloaded root certificate is then placed in a trusted root certificate storage container and does not need to be re-downloaded by the client computer the next time a site that requires the same root is visited. This is also explained further in IBM's Infocenter at http://publib.boulder.ibm.com/infocenter/wmqv6/v6r0/index.jsp!topic=/com.ibm.mq.csq zas.doc/dcwork.htm (Visited Mar. 6, 2006) and is hereby incorporated by reference.

One problem with the current system is that many different certification authorities already exist and new certification authorities are continually being established. The root certificates needed to verify trust and security that are maintained on the client computer are typically included as part of an application such as a web browser (which allows a user to access web pages) or an operating system. Because the root certificates are part of the application, the new certification authorities being established are unable to include their new root certificates on a client computer after the application has been distributed to the public without significant time and cost.

In addition, this limit affects newer advancements in Internet security. For example, a new type of SSL certificate has been developed called an extended validation (EV) SSL certificate. These certificates are the next generation in Internet security as they require rigorous authentication of a business's identity. Merchants using EV SSL certificates must undergo a vetting process that requires the issuing certificate authority to validate company details, such as the legal status, registration number, and address and phone number of the company, prior to issuance.

Users benefit from these new certificates because of the heightened security. Users can be assured that a site containing an EV SSL certificate is a legitimate business. A web browser visiting a site that has an EV SSL certificate relays the heightened assurance to the user by modifying the web browser's appearance. One common display modification is to turn the address bar of the web-browser green and display important verification information next to the web address of the site visited for sites that are using EV SSL certificates.

In order for the EV SSL certificate to display trust information related to the certificate correctly, including visual modifications to the web-browser, the correct root certificate must be present in the client's root storage facility on the local machine and the root certificate must have an EV Policy OID associated with it. Some client computers with a root updating mechanism may be unable to assign EV Policy OIDs to root certificates that are already present in the root certificate program. This means that for a web-browser to use the EV SSL certificate features and relate to the consumer the existence of the added security provided by an EV certificate, the web-browser needs to have a new root certificate that has an applicable EV Policy OID assigned to it embedded in the root certificate program.

Since almost all certification authorities care about ubiquity and cross-certify their EV SSL certificate chains with a legacy root certificate, EV SSL certification will not function properly on some operating systems that have a root updating mechanism because at least one trusted certificate will be found. This means that the new EV root certificate will not be downloaded and added to the root storage facility.

One solution to this problem is to re-distribute the application including the root certificates (e.g. a web browser or operating system) each time a new root certificate is added. This method would place a great burden on both consumers and developers alike because new versions of the application would have to be distributed frequently.

Requiring users to manually download and install new root certificates as they are released can also alleviate the problem. This solution is not realistic as it requires the consumer to understand and know which certificates are needed, let alone how to find and install the needed certificates.

A third solution proposed in the industry is to establish a website that will trigger an SSL/TLS connection to an HTTPS URL that is not configured with the cross-certificate required to provide legacy ubiquity to platforms that do not trust the new root certificate (also called a “beacon” website). The connection returns only the End Entity and any Certificate Authority certificates necessary to build a chain up to the new root certificate.

Some problems with the beacon website solution are that 1) users must set up a link to the HTTPS URL on host entry webpages which is both time consuming and expensive for users with a large number of websites, 2) the consumer may have turned Javascript off in their web browser which could prevent the beacon solution from functioning properly, 3) security warnings may be displayed during the process and cause the consumer to think something is wrong with the website, and 4) entry HTTPS pages may still not provide the visible display of security associated with EV certificates.

One hurdle in the industry is that it has been believed that only the certificates in one certificate chain may be sent during an SSL/TLS session. For example, Apache's™ SSLCertificateChainFile instructions state that the file should contain the certificates “which form a certificate chain” (singular) (http://httpd.apache.org/docs/2.0/mod/mod_ssl.html#sslcertificatechainfile, visited on Dec. 13, 2006).]

### SUMMARY

The inventor discloses that root certificates can be updated on computers that have an updating root mechanism by causing a new root certificate to be sent to a client computer in addition to the legacy certificate chain, causing the new root certificate to be immediately downloaded and installed from the root updating facility.

In one of many possible embodiments of the invention, a client computer requests a certificate from the web-server through an SSL/TLS handshake. During the SSL/TLS handshake, the web-server responds by sending a set of certificates which includes: zero or more legacy root certificates plus zero or more cross-certificates, to allow the client to build the certificate chain(s) up to one or more legacy root certificates; one or more new root certificates plus zero or more cross-certificates, to allow the client to build the certificate chain(s) up to one or more new root certificates.

Various aspects of the cross-certificates, such as their validity period, can be manipulated to increase the likelihood that the client computer relies on the most appropriate of the possible certificate chains.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 depicts a simple embodiment of the invention where a client computer requests a legacy certificate chain from a second computer and the second provides both the legacy certificate chain and a new root certificate in response.

FIG. 2 depicts a flowchart of an embodiment of the invention using a plugin on a web-server running II™.

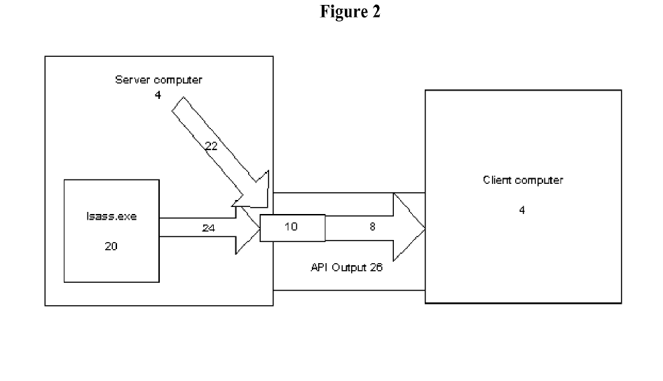

Throughout the drawings, identical reference numbers designate similar, but not necessarily identical, elements.

### DETAILED DESCRIPTION

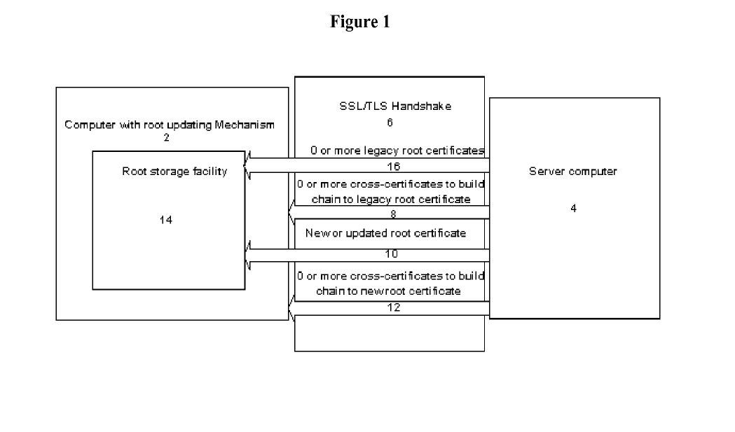

This invention, shown in FIG. 1, discloses a method of updating a root certificate on a computer with a root update mechanism 2 by causing a new root certificate (which includes root certificates that are updated and will replace root certificates already installed) 10 to be sent to the client computer during an SSL/TLS handshake in addition to the legacy certificate chain 8. This causes the new root certificate to automatically be downloaded and installed from the root updating facility.

In one of many possible embodiments of the invention, a client computer with a root update mechanism 2 requests at least one certificate from a second computer 4 (which is often a web server computer) through an SSL/TLS handshake. The second computer 4 responds and sends zero or more cross-certificates 8 to allow the client computer 2 to build certificate chain(s) up to one or more legacy root certificates. The second computer 4 also delivers a new or updated root certificate 10 to the client computer 2. Optionally, the second computer 4 can deliver one or more cross-certificates 12 to allow the client to build a certificate chain up to the new root certificate 10. The client computer 2 then takes the root certificate 10 and stores it in the appropriate root storage facility 14. Finally, the client computer 2 validates the legacy certificate chain 8 using the root certificate 10 supplied by the web-server 4. Various aspects of the cross-certificates, such as their validity period, can be manipulated to ensure that the client displays and relies on the most appropriate of the possible certificate chains.

Normally, web-servers are configured to send only a single certificate chain during the SSL/TLS handshake; however, the inventor has found that a modification to the configuration of a web-server can cause both the new root certificate and the certificate chain to be sent. In one embodiment of the invention, an Apache™ server's mod_ssl module can be configured to include the new root certificate in addition to the certificates which form the legacy certificate chain of the server certificate by pointing the SSLCertificateChainFile directive to a bundle file containing 1) zero or more legacy root certificates; 2) zero or more cross-certificates, to allow the client to build the certificate chain(s) up to one or more legacy root certificates; 3) one or more new root certificates and 4) zero or more cross-certificates, to allow the client to build the certificate chain(s) up to one or more new root certificates.

If the new root certificate included in the bundle file is a PEM-encoded certificate then this configuration will enable EV certificates on computers with an update mechanism. The precise order of the certificates in the bundle file is not always important but may cause the invention to work more efficiently on some clients. Apache™ directives SSLCACertificateFile and SSLCACertificatePath can be used to influence which certificates are sent during the SSL handshakes. Apache™ causes the new root certificate to be installed because, as the inventor has discovered, enough certificates are being sent from the server to build two or more chains (one new root chain and one or more legacy chains), despite the contrary teaching by leaders in the field.

Similar results can be obtained on web-servers running different software by creating a plug-in that modifies or overrides the certificate chaining behavior. For example, the described method can be used on web-servers running Microsoft IIS by creating a plug-in that overrides the certificate chaining behavior using a library such as Microsoft Detours to intercept various calls to the Windows CryptoAPI (specifically the CertGetCertificateChain routine). The plug-in can intercept the API, override the certificates returned by the API, and cause the API to return the new root certificate along with the cross-certificate in the legacy certificate chain. In one embodiment, shown in FIG. 3, the plug-in is loaded into some SSL host process (for IIS 6.0™ this is the 1sass.exe process) 20. The plug-in 22 then intercepts the CertGetCertificateChain API call 24, modifies the output of the API function (in particular the CERT_CHAIN_CONTEXT structure) 26 so that the new root certificate 10 is added to the end of the original chain being sent 8.

The plug-in works best by hooking into the CertCompareCertificateName( ) API function. IIS calls this API to determine if each certificate is a Root Certificate or not. The hooked code then “lies” to IIS. When the two names to be compared both exactly match the Subject/Issuer name in the new root Certificate, the hooked code tells IIS that they do not match. This is enough to make IIS not discard the new root certificate.

The invention has benefits that apply to both EV certificates and normal SSL certificates. EV certificate users will always see EV work the first time a website is visited, and it can often be implemented much easier than using a beacon website. The invention also eliminates the need to modify every web page on a server or require the end user to take action to obtain the new root certificate and can be set up by modifying only the web-server. By installing an EV root certificate in this manner, the invention can automatically and silently enable EV certificates on a computer with a root update mechanism that might otherwise struggle to display the visual EV indicators.

The invention has benefits for any certification authority that relies on legacy root certificates that contains undesirable brand names. By getting a new root certificate that contains desired brand-names installed onto client computers, these certification authorities are much more likely to see their desired brand names displayed in the visual EV indicators.

What is claimed is:

1. A method for installing at least one root certificate on a computer with a root update mechanism, the method comprising at least one first computer with a root update mechanism to receiving through a distributed network at least one root certificate and at least one certificate in the legacy certificate chain from at least one other computer.

2. The method of claim 1, wherein data associated with the at least one certificate in the legacy certificate chain is modified in a manner that forces the at least one root certificate to be downloaded from a root updating facility.

3. The method of claim 1, wherein the at least one root certificate is an extended validation root certificate.

4. The method of claim 1, wherein the at least one root certificate is a root certificate that replaces an existing root certificate in the at least one first computer's root storage facility.

5. The method of claim 1, wherein the distributed network is the Internet and the at least one other computer is a web-server.

6. The method of claim 5, wherein the at least one root certificate is embedded in a configuration file of the at least one other computer.

7. The method of claim 6, wherein at least one cross-certificate required to build a chain to the at least one root certificate is received by the at least one first computer in addition to the at least one root certificate and the at least one cross-certificate required to build a chain to the at least one root certificate is embedded in a configuration file of the at least one other computer.

8. The method of claim 1, wherein the at least one first computer receives from the at least one other computer the at least one root certificate where the at least one other computer has sent the at least one root certificate through an API function and the at least one other computer has intercepted the API function and modified the API function's results to return the at least one root certificate along with the at least one certificate in the legacy certificate chain.

9. The method of claim 1, wherein at least one cross-certificate required to build a chain to the at least one root certificate is received by the at least one first computer in addition to the at least one root certificate.

10. A method for enabling extended validation on a computer with a root update mechanism, the method comprising a first computer with a root update mechanism receiving through a distributed network at least one extended validation root certificate and at least one certificate in the legacy certificate chain from at least one other computer.

11. The method of claim 10, wherein data associated with at least one certificate in the at least one certificate in the legacy certificate chain is modified in a manner that forces the at least one root certificate to be downloaded from a root updating facility.

12. The method of claim 10, wherein the distributed network is the Internet and the at least one other computer is a web server.

13. The method of claim 12, wherein at least one cross-certificate required to build a chain up to the at least one extended validation root certificate is received with the at least one extended validation root certificate.

14. The method of claim 13, wherein at least one cross-certificate required to build a chain up to the at least one extended validation root certificate is embedded in the configuration file with the at least one extended validation root certificate.

15. The method of claim 10, wherein the at least one first computer receives from the at least one other computer the at least one extended validation root certificate where the at least one other computer has sent the at least one extended validation root certificate through an API function and the at least one other computer has intercepted the API function and modified the API function's results to return the at least one extended validation root certificate along with the at least one certificate in the legacy certificate chain.

16. A method for updating at least one certificate on a computer, the method comprising:
receiving a request from at least one first computer node for at least one certificate sending the at least one first computer node at least one updated certificate and at least one certificate in the legacy certificate chain having the at least one first computer node receive and store the at least one updated certificate

17. The method of claim 16, wherein the at least one updated certificate is a root certificate

18. The method of claim 17, with the additional step of the at least one first computer node validating the at least one certificate in the legacy certificate chain using the at least one root certificate.

19. The method of claim 17, wherein data associated with at least one certificate in the legacy certificate chain is modified in a manner that forces the at least one root certificate to be downloaded from a root updating facility.

20. The method of claim 17, wherein the at least one root certificate is a root certificate that replaces an existing root certificate in the first computer's root storage facility.

21. The method of claim 17, wherein the at least one root certificate is an extended validation root certificate.

22. The method of claim 16, wherein the distributed network is the Internet and the at least one other computer is a web server.

23. The method of claim 22, wherein the at least one updated certificate is embedded in a configuration file of the at least one other computer.

24. The method of claim 22, wherein the at least one first computer receives from the at least one other computer the at least one root certificate where the at least one other computer has sent the at least one updated certificate through an API function and the at least one other computer has intercepted the API function and modified the API function's results to return the at least one updated certificate along with the at least one certificate in the legacy certificate chain.

25. A system of downloading a root certificate comprising
at least one webserver
at least one root certificate
at least one certificate in the legacy certificate chain
a means of transmitting both the at least one certificate in the legacy certificate chain and at least one root certificate

26. The system according to claim 25 wherein the at least one root certificate is embedded in the configuration file of the at least one webserver.

27. The system according to claim 25 further comprising at least one cross-certificate required to build a chain to the at least one root certificate.

28. The system according to claim 27 wherein the at least one cross-certificate required to build a chain to the at least one root certificate is embedded into the configuration file of the at least one webserver.

29. The system according to claim 25 wherein the means of transmitting is a means of intercepting an API function on the webbserver and modifying the results of the API function to return the at least one root certificate along with the at least one certificate in the legacy certificate chain.

30. A system for enabling extended validation in a web browser comprising
at least one webserver
at least one root certificate where at least one of the at least on root certificates is an extended validation certificate
at least one certificate in the legacy certificate chain
a means of transmitting both the at least one certificate in the legacy certificate chain and at least one root certificate

31. The system according to claim 30 wherein the at least one root certificate is embedded in the configuration file of the at least one webserver.

32. The system according to claim 30 further comprising at least one cross-certificate required to build a chain to the at least one root certificate.

33. The system according to claim 32 wherein the at least one cross-certificate required to build a chain to the at least one root certificate is embedded into the configuration file of the at least one webserver.

34. The system according to claim 30 wherein the means of transmitting is a means of intercepting an API function on the webbserver and modifying the results of the API function to return the at least one root certificate along with the at least one certificate in the legacy certificate chain.
